(19) United States
(12) Patent Application Publication
(10) Pub. No.: US 2020/0320158 A1
(43) Pub. Date: Oct. 8, 2020

(54) SYSTEM FOR CREATING DYNAMIC LOGIC-BASED CONTENT VARIANTS

(71) Applicant: Boundless Labs Inc., San Francisco, CA (US)

(72) Inventors: David Adams, San Francisco, CA (US); Nolan Evans, San Francisco, CA (US); Steve Hull, San Francisco, CA (US); Adam Anderson, San Francisco, CA (US)

(21) Appl. No.: 16/840,287

(22) Filed: Apr. 3, 2020

Related U.S. Application Data
(60) Provisional application No. 62/831,087, filed on Apr. 8, 2019.
(60) Provisional application No. 62/869,151, filed on Jul. 1, 2019.

(51) Int. Cl. G06F 16/958; G06F 16/957; G06F 9/451

(52) U.S. Cl. CPC G06F 16/986; G06F 9/451; G06F 16/9577

(57) ABSTRACT

The present disclosure provides a system and method for creating websites that is accessible to people without significant web development or programming experience. The disclosed method combines a graphical approach with a logic-based approach by providing a user interface in which site creators may place variant content elements, or “variants.” Placing variants allows the website to dynamically change its appearance based on context. Variants are presented in response to fulfilments of one or more rules, which are created using conditional statements made up of vernacular strings and symbols. Thus, creating rules in order to trigger displays of particular elements is easy for a lay person, and allows for enhanced flexibility in creating websites.

### CROSS-REFERENCE

This application claims priority to U.S. Provisional Application No. 62/831,087, filed Apr. 8, 2019 and U.S. Provisional Application No. 62/860,151, filed Jun. 11, 2019, each of which is entirely incorporated herein by reference in its entirety for all purposes.

### BACKGROUND

It is more important than ever for private individuals and companies to maintain online presences, in order to communicate with peers and customers. It is not always possible for private individuals or small companies to hire web development teams to produce websites that suit their needs. In addition, popular website generators may not offer much flexibility with designs, and thus, do not effectively enable their prospective users to create dynamically varying websites. In addition, most people do not have significant website development or programming skills or have the time or money to afford to take classes to learn such skills. Thus, people seeking to establish online presences are often faced with either incurring significant expenses hiring others to build their websites or with building stock websites that are not flexible enough for their particular needs.

There is an opening for a tool that is simple enough for people without significant web development or programming experience to use, but that also allows flexibility to create websites with content that dynamically varies in response to different contexts. Such a tool would powerfully enable larger numbers of people, companies, and entities to establish online footholds that actually suit their particular needs.

### SUMMARY

The disclosed method and system may enable lay people to design dynamic websites by using a web-based user interface generator to build websites using interchangeable variants. Site creators may use a graphical approach to place spaces for variants within a web page and use a logic-based approach to determine under which conditions individual variants are displayed.

In one aspect, a method is disclosed. The method can comprise maintaining a plurality of variant elements, wherein at least one variant element of the plurality of variant elements is for display on a web-based user interface of an electronic device of a user. The method can further comprise maintaining a plurality of rules, wherein at least one rule of the plurality of rules includes at least one condition. The method can further comprise linking the rule to the at least one variant element of the plurality of variant elements, wherein the rule is configured to permit the at least one variant element to be displayed on the user interface when at least the at least one condition is met. The method can further comprise generating the web-based user interface having the at least one variant element embedded therein, wherein the at least one variant element embedded in the web-based user interface is linked to the rule.

In some embodiments, the condition includes an equality.

In some embodiments, the condition includes an inequality.

In some embodiments, the inequality is a greater than statement.

In some embodiments, the inequality is a less than statement.

In some embodiments, an argument of the condition is an object variable.

In some embodiments, a value of the object variable is retrieved from memory.

In some embodiments, a default variant is presented if there is no adherence to the linked rule.

In some embodiments, the variant element is a graphical page element.

In some embodiments, the variant element is plaintext.

In some embodiments, the variant element is a hyperlink.

In some embodiments, the variant element is an image.

In some embodiments, the variant element is a video.

In some embodiments, the method further provides a graphical user interface for exchanging variant elements.

In some embodiments, the graphical user interface provides data records.

In some embodiments, a condition is selected from a group consisting of a login event, a time, a weather condition, a number of page views, a number of registered users, an upload of a file, a download of a file, a playback of an audio file, a playback of a video file, a particular interaction with a piece of content on a page, a keyword search, a sorting of items in a table, and any combination thereof.

In some embodiments, the condition is written using vernacular strings and symbols.

In one aspect, a system is disclosed. The system may comprise a creator user interface, comprising a graphical space for the placement of one or more variant elements. The system also may comprise a variant list, displaying the one or more variant elements stored in computer memory. The system also may comprise a data view, presenting one or more data records comprising data referenced by at least one variant element. The system also may comprise a rule generator, enabling development of one or more rules for display of at least one variant element. Finally, the system may comprise a preview module, enabling presentation of a preview of the web-based user interface.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an illustration of a system for enabling people to create websites with dynamic content;

FIG. 2 illustrates the web-based user interface generator application;

FIG. 3 shows a menu for creating a list of variants;

FIG. 4 shows an illustration of an interface 400 for creating rules using conditional logic;

FIG. 5A shows an illustration of an embodiment of the creator user interface;

FIG. 5B illustrates a content selection menu within the layout;

FIG. 5C illustrates a variant within the layout;

FIG. 5D illustrates a plurality of executable expressions within the record list variant;

FIG. 6 shows an illustration of the data view, in one embodiment;

FIG. 7 illustrates the preview module;

FIG. 8 illustrates a flowchart for a method for generating a web-based user interface; and

FIG. 9 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Disclosed are systems and methods for enabling people without significant web development experience or programming experience to create flexible, dynamic webpages. The disclosed system may use a web-based user interface generator to enable a site creator to build a webpage. The web-based user interface generator can combine a graphical approach to development with a logic-based approach, using interchangeable content elements, hereinafter referred to as variants, to dynamically alter the appearance and functionality of the webpage. Using the graphical approach, the site creator may determine where variants are placed on the webpage, as well as appearance characteristics of the displayed variants. Using the logic-based approach, the site creator may develop rules for presenting variants within different contexts.

Variants may include many content types commonly displayed on created websites, such as plaintext, hyperlinks, audio, forms, surveys, buttons, input elements, and video. Embedded variants in a webpage may be swapped for other variants, which may be of a same type or of a different type. Herein, a space containing a variant type is referred to as a variant space. Users may alter configurations of variants within variant spaces, in order to alter designs of the variants or to display specific content, using the graphical approach of the disclosed system.

In order to display specific variants, site creators may employ conditional statements, using the logic-based approach of the disclosed system. When the conditions in these statements are met, a particular variant is displayed within a variant space. When different conditions are met, another variant of the same variant type, or of a different variant type, may be displayed instead. The conditions under which variants are displayed may represent different contexts, such as login events of users, times or dates, numbers of active users, news events, or other contexts.

Variants may have, embedded within themselves, executable statements, allowing more flexibility for displayed content. Executable statements may retrieve data from data records stored in memory, either locally or over a network. The data may be retrieved at runtime and used as arguments in executable statements comprising functions or methods, which are immediately executed and configured to display the content when the webpage loads.

### Web-Based Interface System and Method

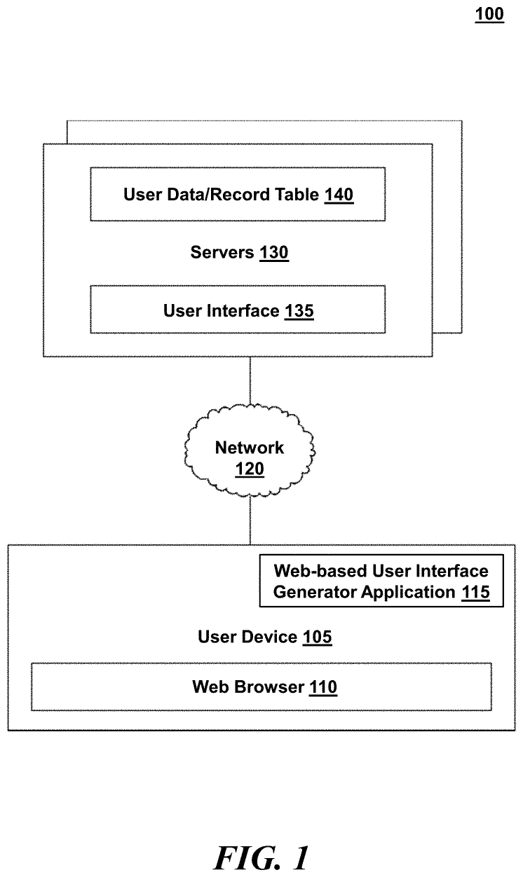

FIG. 1 shows an illustration of a system 100 for enabling people to create websites with dynamic content. The system 100 includes a user device 105, a network 120, and one or more servers 130.

The user device 105 may be any network-connected computing device, capable of storing user data and executing applications. The user device 105 may be a mobile device, such as a cellular phone, a smartphone, a tablet computer, a laptop computer, or a desktop computer. The user device 105 may be handheld. The user device may be a wearable device. The user device may be a non-mobile device. A user device can also include any other media content player, for example, a set-top box, a television set, a video game system, a virtual reality system, or any electronic device capable of providing or rendering data. The user device 105 may be connected to an internet network, a local area network (LAN), a wide-area network (WAN) such as the Internet, a telecommunications network, a data network, or another type of network. The user device 105 may be connected to the network via wired or wireless communication methods.

A user device 105 may comprise memory storage units which may comprise non-transitory computer readable medium comprising code, logic, or instructions for performing one or more steps. A user device may also comprise one or more processors capable of executing one or more steps, for instance in accordance with the non-transitory computer readable media. The user device 105 may comprise a display showing a graphical user interface (GUI). The user device 105 may accept inputs via a user interactive device. Examples of such user interactive devices may include a keyboard, button, mouse, touchscreen, touchpad, joystick, trackball, camera, microphone, motion sensor, heat sensor, inertial sensor, or any other type of user interactive device. For example, a user may input data into the data exchange system or to one or more applications, or otherwise create data by interacting with or navigating the one or more applications, via one or more user interactive devices. The user device 105 may be capable of executing software or applications provided by one or more systems, such as a web-based user interface generator.

The user device includes a web-based user interface generator application 115. The web-based user interface generator is configured to enable users without significant programming or web development experience to build webpages that have flexible variant elements that adapt with respect to changing conditions. Conditions may include a particular user being logged into the webpage, a time of day, week, or year, a date, a weather condition, a number of page views, a number of registered users, an upload or download of a file, playback of an audio or video file, a particular interaction with a piece of content on the page, a keyword search, a sorting of items in a table, any combination of the listed events, or another type of event. The web-based user interface generator 115 may allow site creators to place variant elements in variant spaces within a layout. Additionally, the web-based user interface may allow site creators to define which conditions influence presentation of particular variants to users viewing the webpages by allowing the site creators to define rules.

The user device 105 includes a web browser 110, for viewing content accessible via the network 120. The web browser 110 may be configured to load and enable users to view webpages created using the web-based user interface generator 115.

The user device many have storage, in order to store local user data, variants, and other pieces of content. The storage may be memory, such as ROM, RAM, or flash memory. Local user data may be stored in document form, such as in a spreadsheet or XML document.

The network 103 may be a wireless network, wired network or a combination of both. For example, the network may comprise one or more of the Internet, an intranet, a cellular network, a home network, a person area network, etc., through an ISP, cellular, or broadband cable provider, and the like. The network 103 can comprise an internet protocol interfaces, such as one or more network components, data servers, connection nodes, switches, and the like. The network may be a wireless network, a local area network (LAN), a wireless LAN (WLAN), a metropolitan area network (MAN), a wireless MAN (WMAN), a wide area network (WAN), a wireless WAN (WWAN), a personal area network (PAN), or a wireless PAN (WPAN). The network may be configured to operate in accordance with existing IEEE 802.11, 802.11a, 802.11b, 802.11e, 802.11g, 802.11h, 802.11i, 802.11n, 802.16, 802.16d, 802.16e standards and/or future versions and/or derivatives.

The servers 130 provide resources that enable the web-based user interface generator application 115 to create websites that are hosted on the network 120. A server may be co-located on the user device with the web-based user interface generator applications or located on another computer. The system 100 may also use a distributed or federated server environment, in which user data and user interface resources are jointly maintained by multiple servers. The servers 130 may store user data, from users that may access the website created by the site creator. The servers may store the web-based user interface 135 created by the web-based user interface generator application 115.

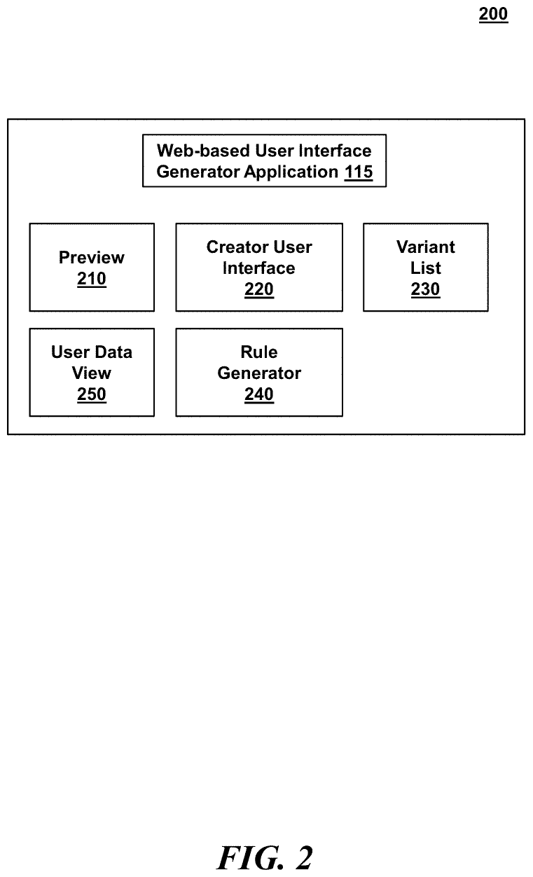

FIG. 2 illustrates the web-based user interface generator application 115. FIG. 2 includes a preview module 210, a creator user interface 220, a variant list 230, a data view 250, and a rule generator 240. The web-based user interface generator application 115 can synthesize a graphical approach to web design with a logic-based approach by allowing site creators to customize graphical aspects of variants while controlling presentation of specific variants using rules.

The preview module 210 can show a preview of the website created using the web-based user interface. The preview of the website may be configured to show the website as it would be seen by a user accessing the webpage from a network. The preview module may be configured to show information that may allow the site creator to debug the created website. For example, the preview module may show what data a variant element may reference, or show underlying code or tags modifying visual characteristics of the variant element. The preview module may allow the site creator to see the website as a guest user, a user with permissions, or as an administrator.

The creator user interface 220 provides a graphical display allowing site creators to place content elements, including variants, on a created webpage. The creator user interface may include a layout or background upon which objects are placed. Variant objects may be placed within a variant space, or bounding box within which variants of a particular type may be placed.

The variant list 230 shows a list of variants maintained in memory, either on device memory or on the servers 130, that may be presented on the created webpage. The variant list may be a drop-down menu. The variant list may include an infinite number of variants. The variant list may be organized by variant type. For example, image variants, video variants, and audio variants may be displayed in different lists. In addition, variant lists may pertain to particular variant spaces.

The data view 250 allows the site creator to view data records, which may correspond to user data, in order to obtain information for presenting variants. Variants may reference particular data records in order to display particular content. In addition, variants may be triggered to be presented only when particular data records may be stored in memory. Data records may include identifiers that allow them to be accessed in memory when specifically called upon by a function or method. The data view may store records in a tabular format, in a spreadsheet, as a list, as a hierarchy, as a tree, or as a graph.

The rule generator 240 allows the site creator to develop rules for dynamically presenting variants. A rule may include one or more relations between variables and employ one or more conditional statements. The conditional statements may be written using vernacular, which enables rules to be written easily by site creators without significant programming or web development experience. A site creator may create an infinite number of rules. Rules may be stored in memory locally, or in the servers 130. Rules may also be exported to other computing devices.

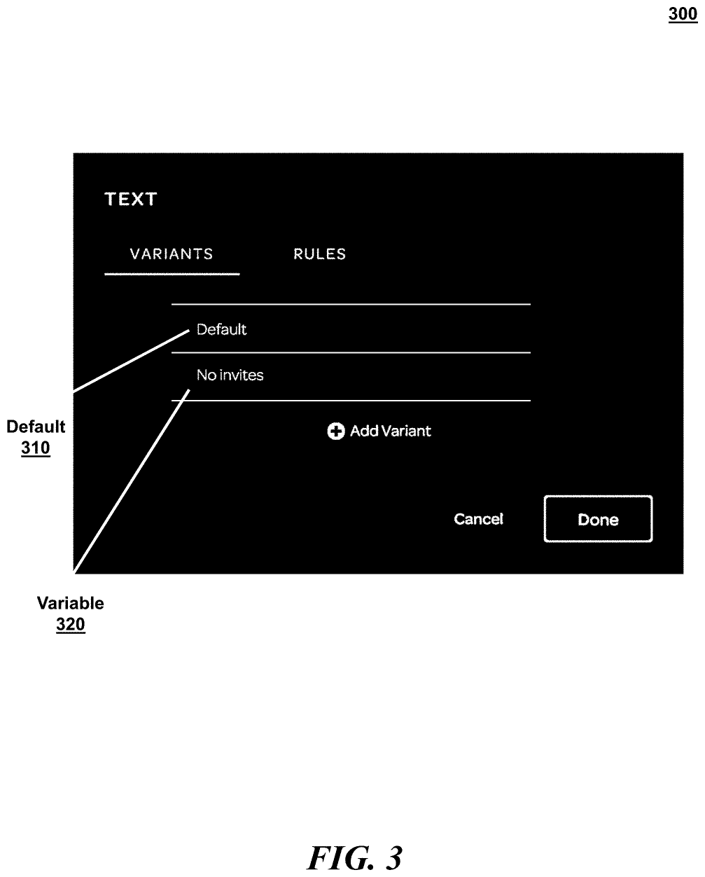

FIG. 3 shows a menu for creating a list of variants. The embodiment of FIG. 3 includes a default variant 310 and a variable variant 320 (entitled “No Invites”). The default variant 310 may be displayed when no rules have been fulfilled, while the variable variant 320 may be displayed when one or more rules is fulfilled. FIG. 3 also shows that additional variants may be added. The variants shown in FIG. 3 are text variants, but variants may also be hyperlink, multimedia, table, or graphical variants. Variants may correspond with predetermined locations on particular web pages. Individual variants may also be common to multiple pages. A single rule may control display of such common variants across all of the pages, or multiple rules may be used to display the common variants on some pages and not others. The list may include variants displayed within a particular context or on a particular section of a web page. Variants may be added without limit. Site creators may export variants to other users, in order to enable the other users to use them for creating websites.

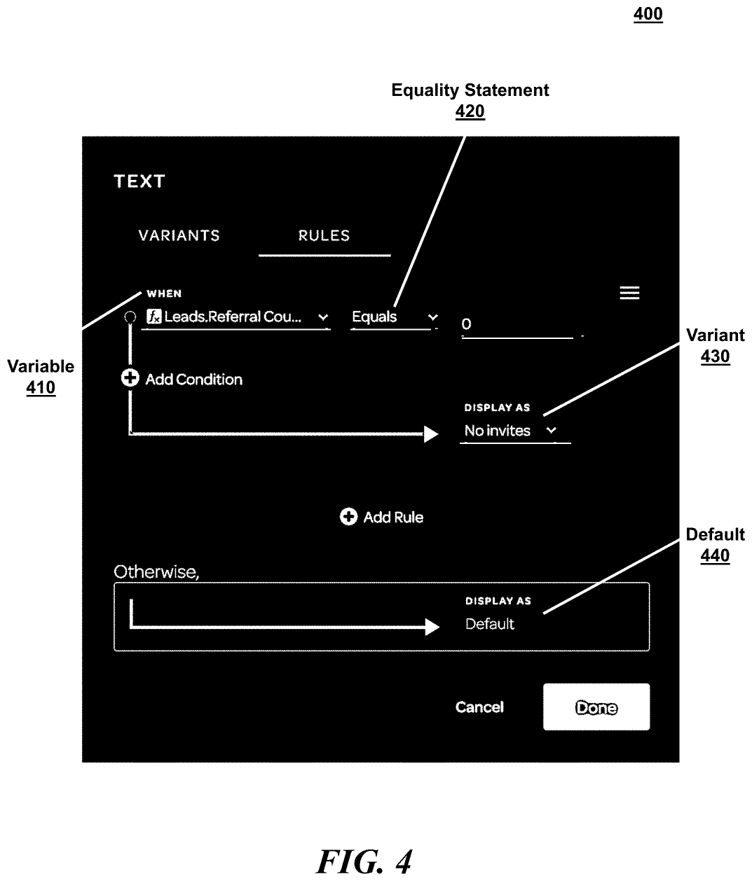

FIG. 4 shows an illustration of an interface 400 for creating rules using conditional logic. The interface 400 includes a rule comprising a conditional statement with variables 410 related by an equality statement 420. An individual rule may comprise one or more conditions. A rule may correspond with a display of a particular variant, such as “No Invites” variant 430. Multiple rules may be added to display many related variants in a particular place, given the contexts in which variants may be preferred to be presented by developers. For example, custom video variants may be presented to users who are determined to be in different geographic regions. Rules may also be used to control locations of displayed variants on particular pages or change which pages the variants are displayed on. Rules may also control dynamic motion of variants across a page. A site creator may be able to link presentation of one or more variant types to a login event of a particular user.

Examples of conditional phrases may include “while”, “when”, “if”, and “do . . . while.” A parameter may include an object and a function associated with the object. In the illustration of FIG. 4, the object is “Leads” and the function is “Referral Count”, referring to a total number of referrals or invites from leads in the system.

Example relations may be equality or inequality statements, such as “does not equal”, “greater than or equal to”, “less than or equal to”, “less than”, “greater than”, and “equals.”

Variables may be numbers, such as integers or floating point numbers. They may also be characters or strings.

In the illustration of FIG. 4, the rule states that the “No Invites” variant 430 is displayed when Leads.Referral Count is equal to zero. This means that when the total number of referrals from all leads is equal to zero, content signifying that no invites have been issued is displayed. Otherwise, the page displays the “Default” variant 440.

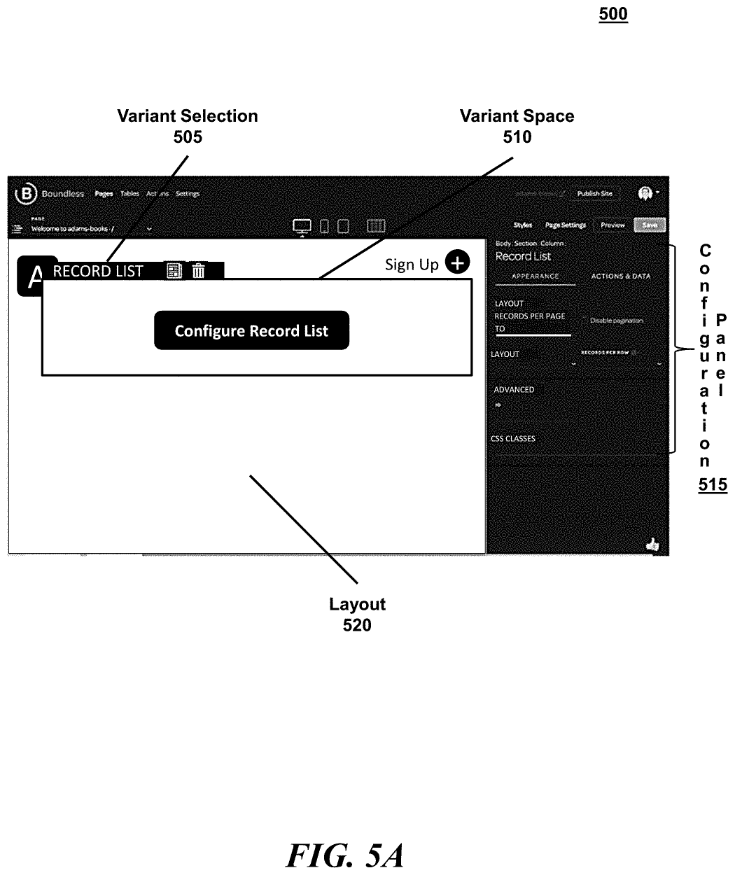

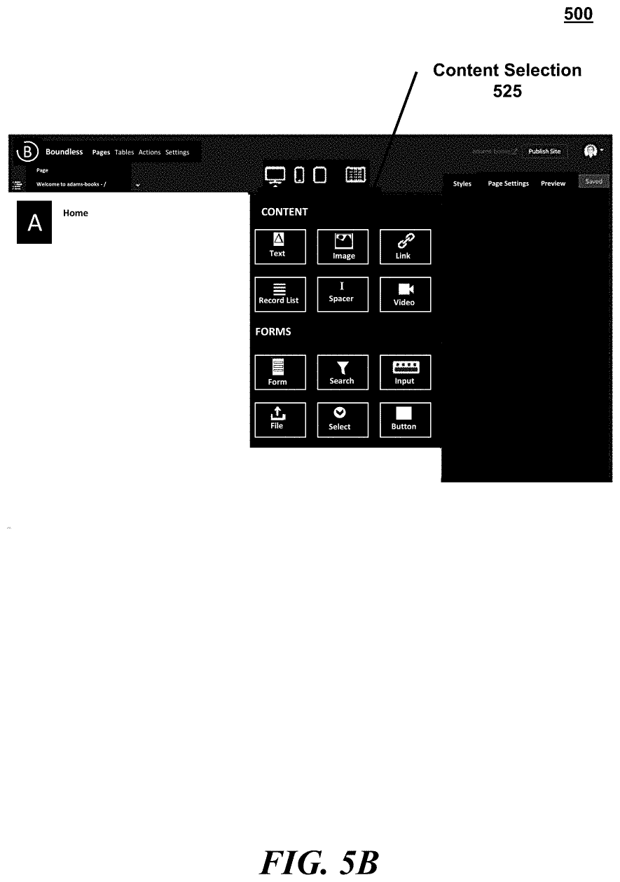

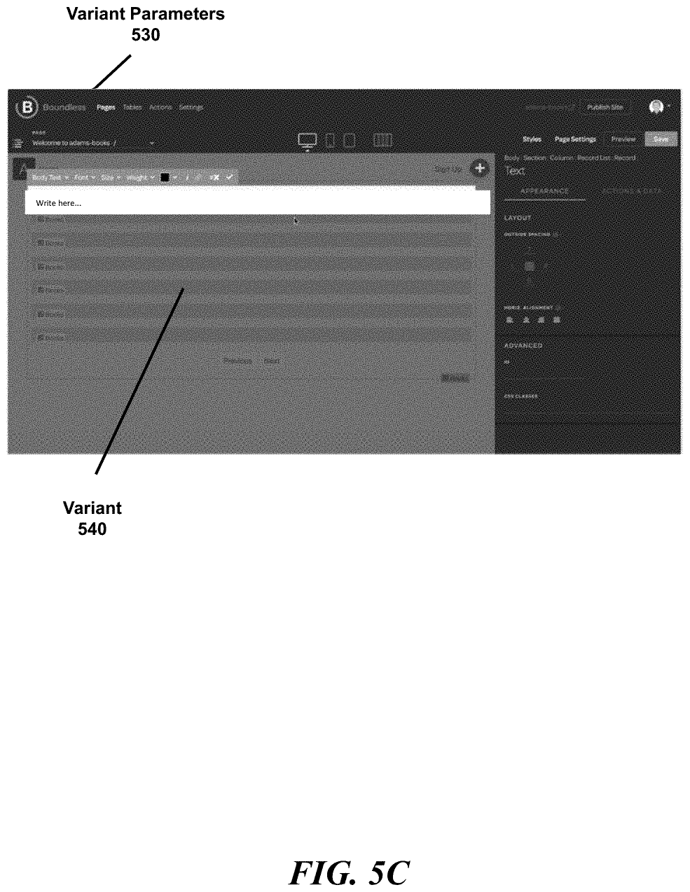

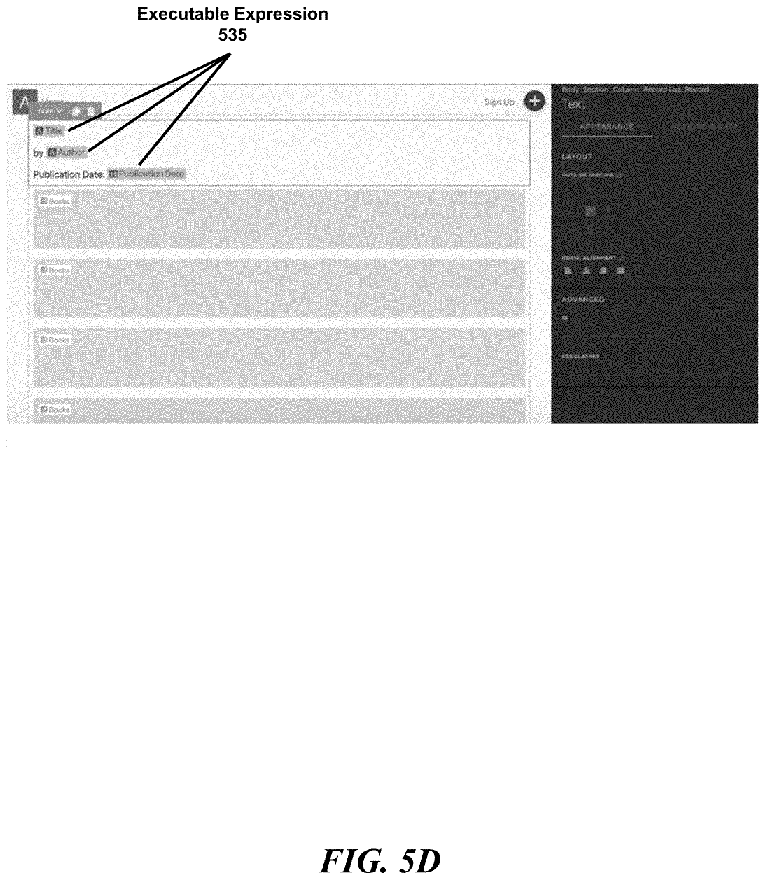

FIG. 5A shows an illustration of an embodiment of the creator user interface 220. The embodiment of FIG. 5A includes a layout 520, a variant selection menu 505, a variant space 510, and a configuration panel 515. The embodiments of FIGS. 5A-D comprise the graphical approach of the web-based user interface generator 115.

Layout 520 is a background for the website created with the web-based user interface generator 115. The site creator may be able to embed variants into the website by placing one or more variant spaces on the layout 520. The site creator may be able to change a color of the layout 520. The layout 520 may be modified to display a web page on a desktop or laptop computer or a mobile device, such as a smartphone or tablet. The layout 520 may include a menu from which a user may select a webpage for modification. The menu may display pages in a list or in a tree-based hierarchy, or show pages connected by hyperlinks.

Variant space 510 is a bounded area within the layout within which a variant may be embedded. In the embodiment of FIG. 5A, the variant space 510 is rectangular. In other embodiments, variant spaces may square, circular, triangular, trapezoidal, or another shape. The user may be able to select a variant type to assign to the variant space. This allows a selection of, or any of, the variants to be embedded within the layout in the variant space. Upon the fulfillment of a rule, the variant output of the rule may be displayed in the variant space. Variant spaces may be pre-configured to display particular variants when one or more rules are fulfilled. For example, upon execution of a plurality of rules, two separate variants may be suitable candidates for display in a particular variant space. The user may be able to select which variant is displayed in such a scenario. The user may be able to determine an order of preference for the fulfilled rules. A user may be able to rank variants by preference and display a more preferred variant if one or more variant is able to be presented. A site creator may add or remove variants which may be selected for presentation within a particular variant space. If multiple rules are fulfilled such that multiple variants may be displayed concurrently in a particular variant space, the system may devise a method for selecting a variant from the list (e.g., the first variant in the list, the last variant in the list, a random variant, or a variant that the site creator has indicated is a preferred choice).

Configuration panel 515 allows the site creator to add variants to layout 520, or to modify design features of variant elements within the website. Elements which can be modified using the configuration panel 515 include variants, variant spaces, and content items within variants. For example, the configuration panel may be used to modify a record list variant to include 10 records. The configuration panel 515 may also be used to modify the records themselves. For example, the configuration panel may be used to alter a text alignment or a font size.

The variant selection 505 allows the user to modify, within the creator user interface, visual characteristics of variants that may be presented in the variant space 510. For example, users may be able to modify font characteristics (size, weight, type of font), video playback characteristics (speed), image characteristics (brightness, contrast, size, sharpness, saturation), and audio playback characteristics (volume), depending on whether the variant within the variant space 510 is a text variant, a video variant, an image variant, or an audio variant.

FIG. 5B illustrates a content selection menu 525 within the layout 520. The content selection window allows the site creator to select content elements, which may be static content elements or variant content elements. The content selection menu enables the site creator to select pieces of content including text, images, links, record lists, spacers, videos, forms, search bars, input fields, files, selection menus, and buttons.

FIG. 5C illustrates a variant 540 within the layout 520. In FIG. 5C, the variant is a record list with parameters 530. The parameters relate to the text within the record list, and modify the font, font size, and other text display features. Also included is an option to embed an executable expression in the record list variant.

FIG. 5D illustrates a plurality of executable expressions 535 within the record list variant 540. The executable expressions, in the embodiment of FIG. 5D, are vernacular tags that reference data stored in one or more data records. The data records may be stored in memory on the user device or within the servers 130. When the webpage is loaded in the web browser, the executable expressions 535 may be immediately executed at runtime.

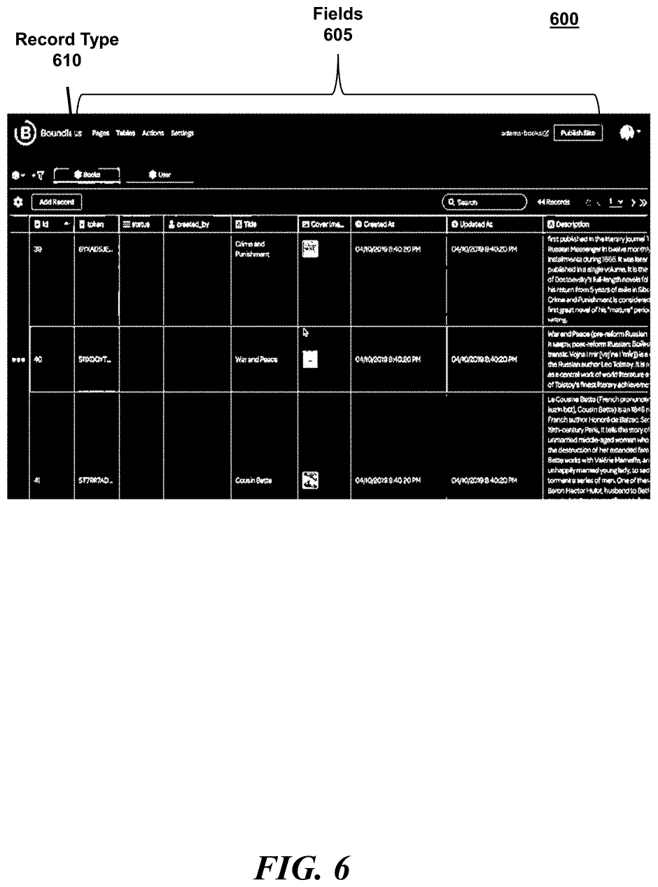

FIG. 6 shows an illustration of the data view 250, in one embodiment. The data view 250 allows the user to view, modify, and update data records. The data records may be stored in tables. The data records may include records of users, objects, and variables belonging to instances of the users or of the objects. The data view 250 shows fields 605 for a record type 610.

Records within the tables may have many characteristics, represented by fields presented to the user viewing the data table. For object records, fields 605 may include identifiers, tokens, status indicators, and other attributes. Attributes may be customizable, based on the objects stored within the record. Attributes may be plaintext or may have embedded links, such as media links or other files. Users may be able to search through data records for specific data records.

The embodiment of FIG. 6 shows a record table displaying records of books. Each book has an identifier, which is a number showing the book's place in the table. Each book record is also associated with a unique token, which may be used to point to its corresponding record in order to retrieve data stored in the table. Book records, in this example table, also include status indicators, fields designating users who created the individual records, titles, timestamps showing when records were created or accessed, images corresponding to the records, and descriptions. Users may define fields to assign to table records. Tables may be created using spreadsheets, comma-separated value (CSV) lists, XML files, or other documents, and imported into the server, or downloaded from a location on a network. Records may be imported from social networks, online databases, or applications that enable users to store data, after users have provided permission to share their data. Users may also customize tables within the user interface to add or remove fields.

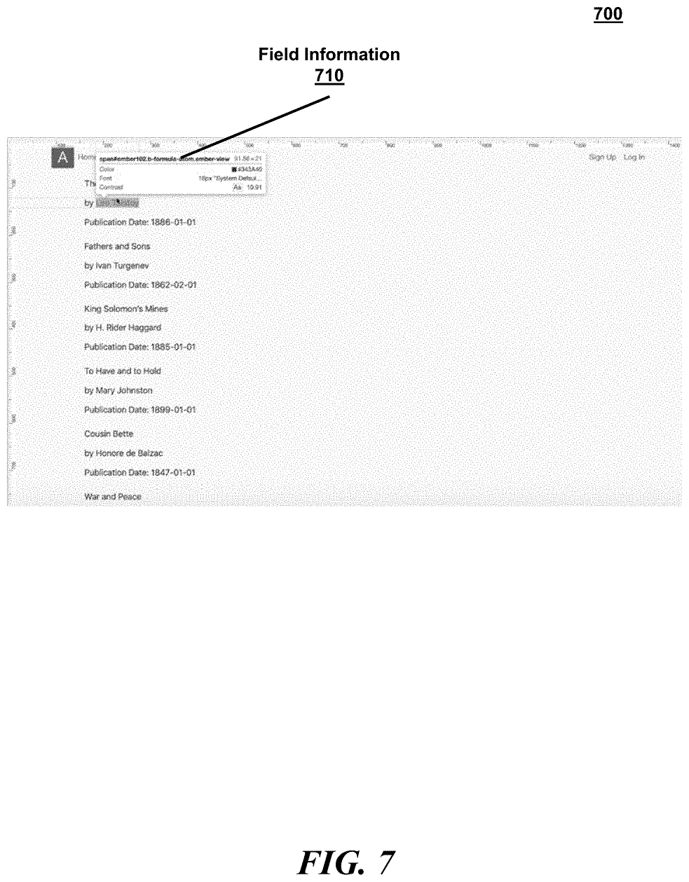

FIG. 7 illustrates the preview module 210. The preview module 710 may allow a site creator to view the site as it would be published. The site creator may be able to inspect variants or components of variants, in order to ensure that content displayed is related to appropriate data.

In the embodiment of FIG. 7, the preview module shows a record list of book records, as it would be displayed in the web browser. When the site creator mouses over an author name, the preview mode displays information about the author name field. Specifically, the preview mode displays the name of the function for displaying the author name, and display parameters such as the font type, font color, font size, contrast, and the size of the text field.

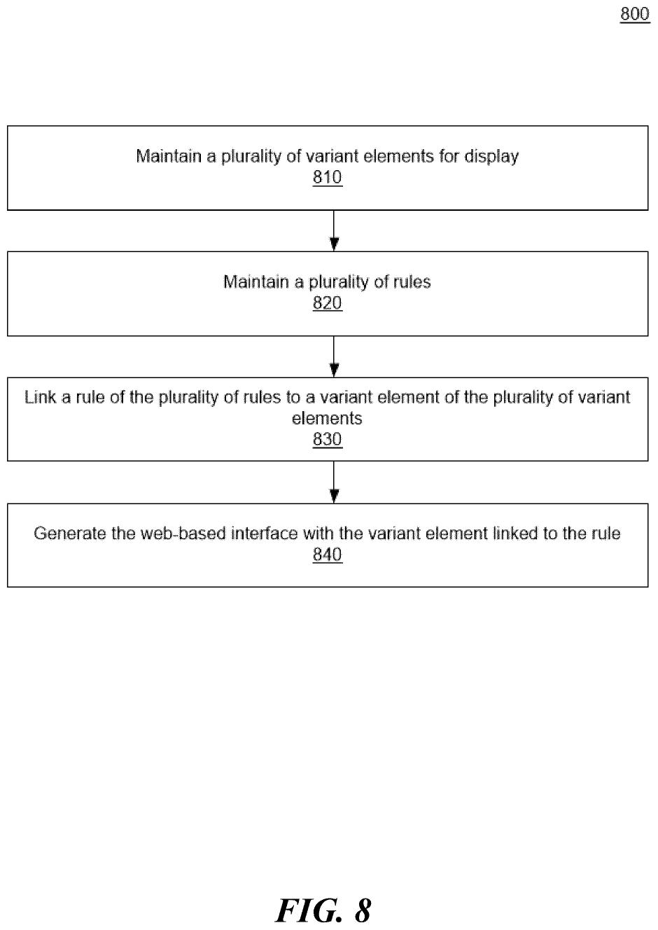

FIG. 8 illustrates a flowchart for a method for generating a web-based user interface. The web-based user interface may be a webpage displayed in a browser, and accessible via a network, such as the Internet.

A server, such as the one of the servers 130, may maintain a plurality of variant elements for display on the web-based user interface 135 (810). The variant elements may be unmodifiable pieces of content, such as media files, or may be modifiable objects, such as record tables. Site creators may create new variants and store them in memory. Variants may be maintained locally, e.g., on device memory, or may be maintained remotely, e.g., by a cloud service provider. The variant elements may be configured to be displayed within variant spaces, which may be placed by the site creator on the layout. Within the layout, the user may modify presentations of individual variants using a drop-down menu.

The server may also maintain a plurality of rules, which may be made up of conditional statements (820). In order to be easy to design for a person without significant programming or web development experience, the rules may employ vernacular strings and symbols. Vernacular strings may comprise whole words or phrases. They may be used to describe variables corresponding to particular entities. For example, “Book.numberOfPages” may be used to designate a number of pages within a book object. Rules may also be maintained locally, e.g., on the site creator's device memory, or remotely.

The site creator can link a rule to a variant element, triggering the variant element content to be displayed when the rule is fulfilled (830). In some embodiments, multiple rules may need to be fulfilled to trigger display of a particular variant element. In other embodiments, fulfillment of a particular rule may trigger display of more than one particular variant element.

The web-based user interface can be generated with at least one variant element embedded (840). In an event no rules exist, one or more default variants may be displayed within the generated web-based user interface. The web-based user interface may be configured for display in a web browser. The web-based user interface may also be particularly configured for display on different types of devices, such as on mobile computing devices (e.g., smartphones and tablets), on desktop computers, on laptop computers, or on large monitors.

In some situations, multiple variants may be eligible for presentation within a particular variant space, when rules corresponding to the multiple variants are fulfilled. In these situations, the site creator may describe an order of preference and rank variants, with the highest-ranked variant displayed for presentation. The site creator may also develop additional rules for selection of a variant from the multiple variants to be presented, in the case of such a conflict.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Computer Systems

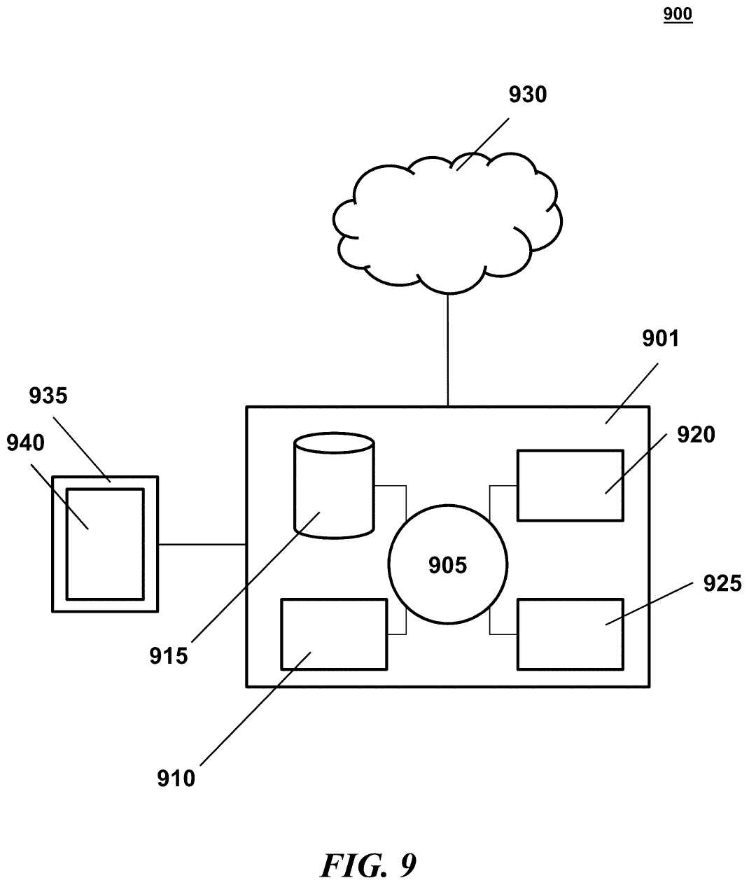

The present disclosure provides computer systems that are programmed to implement methods of the disclosure. FIG. 9 shows a computer system 901 that is programmed or otherwise configured to provide developers with marketing tools. The computer system 901 can regulate various aspects of configuring variants of the present disclosure, such as, for example, writing conditions and collecting data. The computer system 901 can be an electronic device of a user or a computer system that is remotely located with respect to the electronic device. The electronic device can be a mobile electronic device.

The computer system 901 includes a central processing unit (CPU, also “processor” and “computer processor” herein) 905, which can be a single core or multi core processor, or a plurality of processors for parallel processing. The computer system 901 also includes memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 905 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the computer system 901, can implement a peer-to-peer network, which may enable devices coupled to the computer system 901 to behave as a client or a server.

The CPU 905 can execute a sequence of machine-readable instructions, which can be embodied in a program or software. The instructions may be stored in a memory location, such as the memory 910. The instructions can be directed to the CPU 905, which can subsequently program or otherwise configure the CPU 905 to implement methods of the present disclosure. Examples of operations performed by the CPU 905 can include fetch, decode, execute, and writeback.

The CPU 905 can be part of a circuit, such as an integrated circuit. One or more other components of the system 901 can be included in the circuit. In some cases, the circuit is an application specific integrated circuit (ASIC).

The storage unit 915 can store files, such as drivers, libraries and saved programs. The storage unit 915 can store user data, e.g., user preferences and user programs. The computer system 901 in some cases can include one or more additional data storage units that are external to the computer system 901, such as located on a remote server that is in communication with the computer system 901 through an intranet or the Internet.

The computer system 901 can communicate with one or more remote computer systems through the network 930. For instance, the computer system 901 can communicate with a remote computer system of a user (e.g., a developer or a client). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 905. In some cases, the code can be retrieved from the storage unit 915 and stored on the memory 910 for ready access by the processor 905. In some situations, the electronic storage unit 915 can be precluded, and machine-executable instructions are stored on memory 910.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 901 can include or be in communication with an electronic display 935 that comprises a user interface (UI) 940 for providing, for example, customizing websites. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 905. The algorithm can, for example, determine customized variants for segmented users.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for generating a web-based user interface, said method comprising:
(a) maintaining a plurality of variant elements, wherein at least one variant element of said plurality of variant elements is for display on a web-based user interface of an electronic device of a user;
(b) maintaining a plurality of rules, wherein at least one rule of said plurality of rules includes at least one condition;
(c) linking said rule to said at least one variant element of said plurality of variant elements, wherein said rule is configured to permit said at least one variant element to be displayed on said user interface when at least said at least one condition is met; and
(d) generating said web-based user interface having said at least one variant element embedded therein, wherein said at least one variant element embedded in said web-based user interface is linked to said rule.

2. The method of claim 1, wherein said at least one condition includes an equality.

3. The method of claim 1, wherein said at least one condition includes an inequality.

4. The method of claim 3, wherein said inequality is a greater than statement.

5. The method of claim 3, wherein said inequality is a less than statement.

6. The method of claim 1, wherein an argument of said at least one condition is an object variable.

7. The method of claim 1, wherein a value of said object variable is retrieved from memory.

8. The method of claim 1, wherein a default variant is presented if there is no adherence to said linked rule.

9. The method of claim 1, wherein said at least one variant element is a graphical page element.

10. The method of claim 8, wherein said at least one variant element is plaintext.

11. The method of claim 8, wherein said at least one variant element is a hyperlink.

12. The method of claim 8, wherein said at least one variant element is an image.

13. The method of claim 8, wherein said at least one variant element is a video.

14. The method of claim 1, further providing a graphical user interface for exchanging variant elements.

15. The method of claim 14, wherein said graphical user interface provides data records.

16. The method of claim 1, wherein said at least one condition is selected from a group consisting of a login event, a time, a weather condition, a number of page views, a number of registered users, an upload of a file, a download of a file, a playback of an audio file, a playback of a video file, a particular interaction with a piece of content on a page, a keyword search, a sorting of items in a table, and any combination thereof.

17. The method of claim 1, wherein said at least one condition is written using vernacular strings and symbols.

18. (canceled)

19. A system for generating a web-based user interface, comprising:
(a) computer memory configured to maintain a plurality of variant elements, wherein at least one variant element of said plurality of variant elements is for display on a web-based user interface of an electronic device of a user and further configured to maintain a plurality of rules, wherein at least one rule of said plurality of rules includes at least one condition; and
(b) one or more computer processors operatively coupled to said computer memory, wherein said one or more computer processors are individually or collectively configured to (i) link said rule to said at least one variant element of said plurality of variant elements, wherein said rule is configured to permit said at least one variant element to be displayed on said user interface when at least said at least one condition is met; and (ii) generate said web-based user interface having said at least one variant element embedded therein, wherein said at least one variant element embedded in said web-based user interface is linked to said rule.

20. A non-transitory computer-readable medium comprising machine-executable code that, upon execution by one or more computer processors, implements a method for generating a web-based user interface, said method comprising:
(a) maintaining a plurality of variant elements, wherein at least one variant element of said plurality of variant elements is for display on a web-based user interface of an electronic device of a user;
(b) maintaining a plurality of rules, wherein at least one rule of said plurality of rules includes at least one condition;
(c) linking said rule to said at least one variant element of said plurality of variant elements, wherein said rule is configured to permit said at least one variant element to be displayed on said user interface when at least said at least one condition is met; and
(d) generating said web-based user interface having said at least one variant element embedded therein, wherein said at least one variant element embedded in said web-based user interface is linked to said rule.
